(19) United States
(12) Patent Application Publication
(10) Pub. No.: US 2004/0234441 A1
(43) Pub. Date: Nov. 25, 2004

(54) Chemical and thermal decomposition of ammonium sulphate into ammonia and sulphuric acid

(76) Inventor: Tord Oeystein Hansen, Hvalstad (NO)

Correspondence Address: Ole Johan Aulie, PO Box 188, Lysaker, N-1325, NO

(21) Appl. No.: 10/487,811

(22) PCT Filed: Sep. 26, 2002
(86) PCT No.: PCT/NO02/00344

(30) Foreign Application Priority Data
Sep. 27, 2001 (NO) 20014699

(51) Int. Cl. C01C 1/02

(52) U.S. Cl. 423/356

(57) ABSTRACT

A method is described for manufacturing ammonia and sulphuric acid by decomposition of ammonium sulphate by a chemical and thermal handling process The method concerns mixing of ammonium sulphate with concentrated sulphuric acid, where the mixture is heated to a temperature above 235° C., whereby ammonium sulphate is melted, and thereafter by heating the mixture to above 280° C. but below the boiling point of concentrated sulphuric acid. It is hereby achieved to decompose ammonium sulphate into ammonia gas and sulphuric acid liquid simultaneously, where the produced sulphuric acid during the reaction time is mixed ideally with the concentrated sulphuric acid from the initial basis mixture.

The present invention relates to a method for decomposition of ammonium sulphate ((NH4)2SO4 into ammonia (NH3) and sulphuric acid-(H2SO4) by chemical and thermal treatment.

Ammonium sulphate falls out as a by-product from several differerent chemical processes. Ammonium sulphate was earlier used as a fertilizer component, but is later substituted by ammonium nitrate for this purpose. Ammonium sulphate is still to a certain extent used as a fertilizer component in some developing countries. However is ammonium sulphate in most processing cases considered to be an undesired by-product with limited marketing possibilities.

Ammoniumsulphate is a water soluble crystalline product with a melting point at 235° C. At temperatures above 280° C. ammonium sulphate decomposes into ammonia, sulphur trioxide and nitrogenous gases.

Within the different process combinations where ammonium sulphate is formed, are sulphuric acid and ammonia in most cases involved as input materials. Under these conditions there will be favorable both of environmental and economical reasons, to decompose ammoniumsulpate into ammonia and sulphuric acid in order to recirculate the input materials of the process, or to obtain saleable products.

There are a some known methodes concerning decomposition of ammonium sulphate descibed in the following documents:

(1) Chemical Abstracts, Vol 65 (1966), Acc. Nr. 70990, Zh. Neorgan. Chim., 1966, 11(7), 1673-8 (Russia)

(2) DE 1151492

(3) DE 1160421

The above listed documents describes methodes where ammonium sulphate by thermal treatment and complete decomposition forms gases of NH3, H20 and SO3/SO2 at temperatures above 350° C. The german patent publications describes further a process involving coke, coal or charcoal as reduction materials under oxygen free conditions where it is achieved to obtain SO2 based sulpuric acid in water solution and where ammonia is seperated out in a circuit with ammoniumhydrogen sulphate and potassium sulphate.

The present invention concerns a method for manufacturing of ammonia gas (NH3) and sulphuric acid (H2SO4) characterized wherein ammonium sulphate ((NH4)2SO4) is mixed with concentrated sulphuric acid, and by heating the mixture to a temperature above 235° C., whereby ammonium sulphate is melted, and thereafter by heating the mixture to above 280° C. but below the boiling point of concentrated sulphuric acid (290° C.-320′), by which ammonium sulphate is decomposed into ammonia gas and sulphuric acid liquid simultanously, and where the produced sulphuric acid during the reaction time is mixed ideally with the concentrated sulphuric acid from the initial basis mixture.

By this method it is achieved to decompose ammonium sulphate to a fully extent into ammonia gas and sulphuric acid liquid, where the ammonia gas during processing is evaporated and separated out from a restsolution consisting of sulphuric acid.

An example of manufacturing proceedure is given as follows.

### EXAMPLE

The basis material consisting of 3-5 mmØ crystalline ammonium sulphate, is mixed with 95-97% concentrated sulphuric acid in a reactor at a weight ratio of ammonium sulphate/sulphuric acid=1/2.

The reactor is heated up to approx 250° C. whereby ammonium sulphate melts out in a separate liquid phase above the concentrated sulphuric acid. The reactor is thereafter heated upto 285° C. whereby ammonium sulphate is decomposed. During decomposition of ammonium sulphate, the ammonia gas formed is evacuated out at the top of the reactor and thereafter cooled down and stored in a seperate tank. The rest product from the decomposition consisting of concentratrd sulphuric acid mixes ideally with the initial sulphuric acid from the basis mixture. After completed reaction, corresponding to approx. 1 hour, the sulphuric acid in the reactor is transfered to a separete intermediate tank for delution with a limited amount of water in order to regulate the acid concentration to about 95-97%. The produced amount of sulphuric acid from the ammonium sulphate decomposition is then transfered to a separate storage tank, while the remaining part of the sulpuric acid is cooled down to about 250° C. and thereafter circulated back to the reactor in a repeating production cycle for decomposition of new ammonium sulphate rawmaterial.

We claim:

1. A method for manufacturing of ammonia gas (NH3) and sulphurid acid (H2SO4) characterized wherein ammonium sulphate ((NH4)2SO4) is mixed with concentrated sulphuric acid, and by heating the mixture to a temperature above 235° C., whereby ammonium sulphate is melted, and thereafter by heating the mixture to above 280° C. but below the boiling point of concentrated sulphuric acid, by which ammonium sulphate is decomposed into ammonia gas and sulphuric acid liquid simultanously, and where the produced sulphuric acid during the reaction time is mixed ideally with the concentrated sulphuric acid from the initial basis mixture.

2. The method of claim 1, characterized wherein the weight ratio ammonium-sulphate/sulphuric-acid is between approx. 2.0-0.1 and where the melting temperature of ammoniumsulphate is kept between approx. 240° C.-270° C. and where the decomposition temperature is kept at approx. 285° C.
